(19) United States
(12) Patent Application Publication
(10) Pub. No.: US 2024/0255453 A1
(43) Pub. Date: Aug. 1, 2024

(54) AUTOIGNITION SYSTEMS TO MEASURE AUTIGNITION TEMPERATURES AND RELATED METHODS

(71) Applicant: Brigham Young University, Provo, UT (US)

(72) Inventors: Mark Edward REDD, Provo, UT (US); W. Vincent WILDING, Springville, UT (US)

(21) Appl. No.: 18/563,265

(22) PCT Filed: Jun. 22, 2022
(86) PCT No.: PCT/US2022/034442

§ 371 Date: Nov. 21, 2023

Related U.S. Application Data
(60) Provisional application No. 63/214,022, filed on Jun. 23, 2021.

(51) Int. Cl. G01N 25/52; F27D 19/00

(52) U.S. Cl. CPC G01N 25/52; F27D 19/00; F27D 2019/0043

(57) ABSTRACT

An example autoignition system includes a pressure vessel defining a vessel chamber. The vessel chamber is configured to be pressurized to about 101 kPa (1 atmosphere). The autoignition system also includes a furnace disposed in the vessel chamber. The furnace defines a furnace chamber and the furnace is configured to control the temperature of the furnace chamber. The furnace also defines at least one sample inlet. The autoignition system additionally includes at least one gas source configured to supply a gas to the vessel chamber thereby pressurizing the vessel chamber to about 101 kPa and at least one pressure sensor configured to determine a pressure of the vessel chamber.

### CROSS-REFERENCE TO RELATED APPLICATION

This application claims priority to U.S. Provisional Patent Application No. 63/214,022 filed on 23 Jun. 2021, the disclosure of which is incorporated herein, in its entirety, by this reference.

### BACKGROUND

ASTM E659 requires experiments measuring autoignition temperatures be performed at 1.0 atmosphere (e.g., 101 kPa) absolute pressure. Such requirements make it difficult or impossible to measure autoignition temperatures at high altitudes, when a low pressure weather autoignition system in present, or in other situations.

### SUMMARY

Embodiments are directed to autoignition systems to measure autoignition temperatures and related methods. In an embodiment, an autoignition system to measure autoignition temperatures is disclosed. The autoignition system includes a pressure vessel including one or more vessel walls defining a vessel chamber and opening. The pressure vessel includes a lid configured to cover the opening and be secured to the one or more vessel walls. The pressure vessel defines at least one gas inlet. The autoignition system also includes a furnace disposed in the chamber. The furnace includes one or more furnace walls defining a furnace chamber. The furnace defines at least one sample opening configured to allow a sample to be disposed in the furnace chamber. The furnace is configured to controllably heat the furnace chamber. The autoignition system further includes at least one gas source in fluid communication with the gas inlet of the pressure vessel and at least one pressure sensor configured to detect a pressure within the vessel chamber.

In an embodiment, a method to measure autoignition temperatures is disclosed. The method includes flowing a gas from at least one gas source into a vessel chamber of a pressure vessel via at least one gas inlet to at least one of increase an absolute pressure of the vessel chamber to 101 kPa or maintain the absolute pressure of the vessel chamber at 101 kPa. The pressure vessel includes one or more vessel walls defining the vessel chamber and an opening. The pressure vessel includes a lid covering the opening and secured to the one or more vessel walls. The absolute pressure of the vessel chamber is detected using at least one pressure sensor. The method also includes increasing a temperature in a furnace chamber of a furnace, the furnace disposed in the vessel chamber. The furnace includes one or more furnace walls defining the furnace chamber. The method further includes disposing at least one sample into the furnace chamber through at least one sample opening defined by the furnace.

In an embodiment, an autoignition system to measure autoignition temperatures is disclosed. The autoignition system includes a pressure vessel including one or more vessel walls defining a vessel chamber and opening. The pressure vessel includes a lid configured to cover the opening and be secured to the one or more vessel walls. The one or more vessel walls include at least one vessel transparent section. The pressure vessel defines at least one gas inlet and at least one gas outlet. The autoignition system also includes a furnace disposed in the chamber. The furnace includes one or more furnace walls defining a furnace chamber. The furnace defines at least one sample opening configured to allow a sample to be disposed in the furnace chamber. The furnace is configured to controllably heat the furnace chamber. The autoignition system also includes a sample dispenser disposed in the vessel chamber and outside of the furnace chamber. The sample dispenser is configured to dispense at least one sample into the furnace chamber through the at least one sample opening. The autoignition system additionally includes at least one gas source in fluid communication with the gas inlet of the pressure vessel, at least one pressure sensor configured to detect a pressure within the vessel chamber, a controller configured to control at least one of a rate at which a gas is provided from the gas source to the vessel chamber or a temperature in the furnace chamber, and at least one safety defining a passageway and a film disposed in or covering the passageway. The film is configured to fail when a pressure differential between the vessel chamber and an exterior of the pressure vessel is about 100 kPa to about 500 kPa.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a schematic cross-sectional view of an autoignition system, according to an embodiment.

FIG. 2A is a cross-sectional schematic of an autoignition system, according to an embodiment.

FIG. 2B is an isometric view of a portion of an autoignition system that includes a sample dispenser disposed over a sample inlet, according to an embodiment.

FIG. 2C is an isometric view of a portion of an autoignition system that includes a sample dispenser disposed over a sample inlet, according to an embodiment.

FIG. 3 is a cross-sectional schematic of an autoignition system including a camera, according to an embodiment.

FIG. 4 is a cross-sectional schematic of an autoignition system including a safety outlet, according to an embodiment.

FIG. 5 is a flow chart of an example method of using any of the autoignition systems disclosed herein, according to an embodiment.

### DETAILED DESCRIPTION

Embodiments are directed to autoignition systems to measure autoignition temperatures and related methods. An example autoignition system includes a pressure vessel defining a vessel chamber. The vessel chamber is configured to be pressurized to about 101 kPa (1 atmosphere). The autoignition system also includes a furnace disposed in the vessel chamber. The furnace defines a furnace chamber and the furnace is configured to control the temperature of the furnace chamber. The furnace also defines at least one sample inlet. The autoignition system additionally includes at least one gas source configured to supply a gas to the vessel chamber, thereby pressurizing the vessel chamber to about 101 kPa and at least one pressure sensor configured to determine a pressure of the vessel chamber.

A method of using the autoignition system includes pressurizing the vessel chamber such that the vessel chamber exhibits a pressure of about 101 kPa. The vessel chamber may be pressurized by flowing gas from the gas source into the vessel chamber. The method also includes disposing the sample (in the furnace chamber. The sample may include, for example, a fuel, a combustible material, a non-combustible material, a solid, a liquid, or a gas. The sample may be disposed in the furnace chamber before or, preferably, after the vessel chamber exhibits 101 kPa. A temperature of the furnace chamber may be incrementally increased until the sample autoignites. The temperature of the furnace chamber at which the sample combusts may be determined

The autoignition systems and methods disclosed herein are an improvement over conventional autoignition systems and method. The conventional autoignition systems and methods for conducting autoignition experiments include a furnace configured to exhibit ambient pressure therein. The temperature of autoignition of a sample depends, in part, on the pressure in the furnace. As such, the standards that governs autoignition experiments (i.e., ASTM E659) often require autoignition experiments be performed at about 101 kPa to prevent the ambient pressure from affecting the results obtained from the autoignition experiments. The requirement that the autoignition experiments be performed at 101 kPa prevents the conventional autoignition systems and methods from being used in several scenarios. In an example, the conventional autoignition systems and methods may not be used in locations having an elevation greater than about 500 feet above sea level since the ambient pressure is typically too far below 101 kPa for autoignition experiments. In an example, the conventional autoignition systems and methods may only be used in certain weather conditions. In particular, the conventional autoignition systems may not be used when a low or high pressure weather system is present since such pressure weather autoignition systems may cause the ambient pressure to deviate too much from 101 kPa for autoignition experiments.

The autoignition systems and method disclosed herein resolve at least these issues of the conventional autoignition systems and methods. For example, the autoignition systems and methods disclosed herein perform the autoignition experiments in a pressure vessel. The pressure in the vessel chamber of the pressure vessel may be controlled such that the pressure remains at about 101 kPa regardless of the ambient pressure. As such, the autoignition systems and methods disclosed herein allow autoignition experiments to be performed at any elevation and regardless of the weather.

It is noted that, unless otherwise stated, the pressures disclosed herein refer to the absolute pressure.

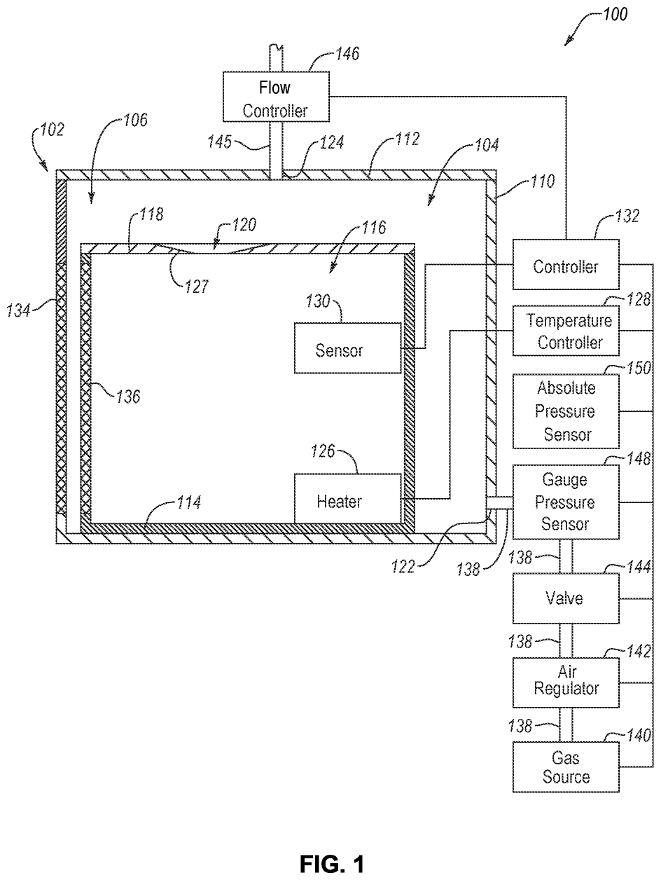

FIG. 1 is a schematic cross-sectional view of an autoignition system 100, according to an embodiment. The autoignition system 100 includes a pressure vessel 102 defining a vessel chamber 104. The autoignition system 100 also includes a furnace 106 disposed in the pressure vessel 102 and at least one gas source system 108 configured to pressurize the autoignition system 100. The autoignition system 100 is configured to cause the vessel chamber 104 to exhibit and maintain a pressure of about 101 kPa thereby allowing autoignition experiments to be conducted in the furnace 106.

The pressure vessel 102 includes one or more vessel walls 110. The vessel walls 110 define the vessel chamber 104. The vessel walls 110 also define an opening (not labelled, covered by the lid 112). The opening allows the vessel chamber 104 to be easily accessible. For example, the opening allows a sample to be provided into the vessel chamber 104 and allows the furnace 106 to be removed from the vessel chamber 104 (e.g., for repair or cleaning). The pressure vessel 102 includes a lid 112 that is configured to completely cover the opening and be secured to the vessel walls 110 such that substantially no air may escape from the pressure vessel 102 except, optionally, at desired locations (e.g., the air outlet 124). In other words, the lid 112 may be configured to cover the opening and be secured to the vessel walls 110 such that substantially no air may flow between the vessel walls 110 and the lid 112. The lid 112 may be secured to the vessel walls 110 using any suitable method, such as with clamps, bolts, or hinges.

The pressure vessel 102 is configured to have a pressure of about 101 kPa within the vessel chamber 104. The pressure within the vessel chamber 104 may be greater than a pressure outside of the pressure vessel 102. For example, the pressure within the vessel chamber 104 may exhibit a gauge pressure (i.e., pressure difference between the vessel chamber 104 and a pressure outside of the pressure vessel 102) that is about 0.5 kPa or greater, about 1 kPa or greater, about 5 kPa or greater, about 10 kPa or greater, about 15 kPa or greater, about 20 kPa or greater, about 30 kPa or greater, about 40 kPa or greater, or in ranges of about 1 kPa to about 10 kPa, about 5 kPa to about 15 kPa, about 10 kPa to about 20 kPa, about 15 kPa to about 30 kPa, or about 20 kPa to about 40 kPa. Due to the pressure difference, the vessel walls 110 and the lid 112 may be formed from a substantially air impermeable material and a material exhibiting sufficient strength that the pressure difference does not cause the pressure vessel to deform. For example, the vessel walls 110 and the lid 112 may be formed a metal (e.g., steel or aluminum), a ceramic (e.g., glass), a rigid polymer, a composite, or combinations thereof. The pressure vessel 102 may also include an O-ring, grease, or other sealant between the vessel walls 110 and the lid 112 to prevent gas from flowing between the vessel walls 110 and the lid 112.

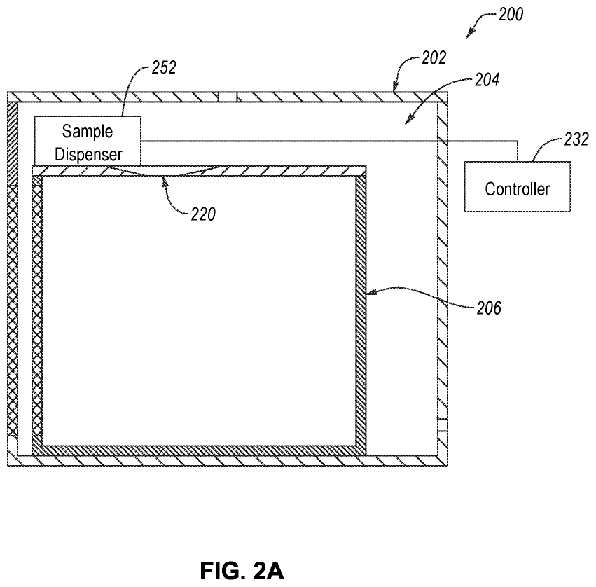

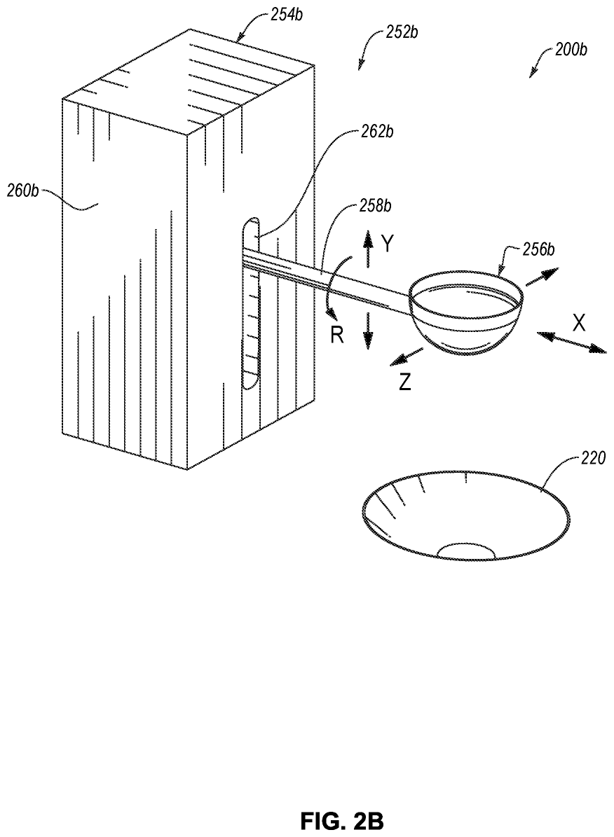

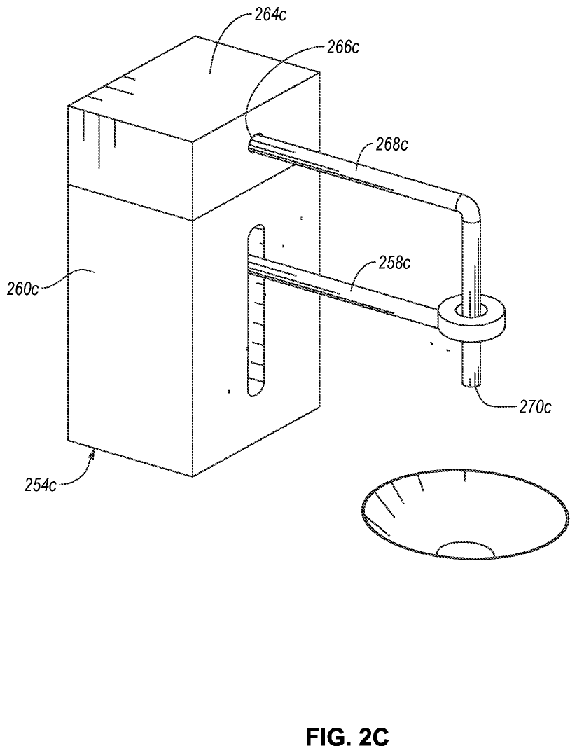

As will be discussed in more detail below, the pressure vessel 102 may be heated by thermal energy escaping the furnace 106. The pressure vessel 102 may exhibit a maximum operating temperature. The maximum operating temperature of the pressure vessel 102 is the maximum temperature that the vessel chamber 104 may exhibit without failure of weakening of the pressure vessel 102, any components disposed in the vessel chamber 104 (e.g., the sample dispenser 252 of FIG. 2A), or any components in fluid communication with the vessel chamber 104 (e.g., the flow controller 146, the gauge pressure sensor 148, etc.). The maximum operating temperature of the pressure vessel 102 may be selected to be about 50° C. to about 100° C., about 75° C. to about 125° C., about 100° C. to about 150° C., about 125° C. to about 175° C., about 150° C. to about 200° C. or about 175° C. to about 300° C. The pressure vessel 102 may include one or more features configured to prevent the temperature in the pressure vessel 102 from exceeding the maximum operating temperature. For example, the pressure vessel 102 may define a gas inlet 122 configured to provide gas to the vessel chamber 104 and a gas outlet 124 configured to remove gas from the vessel chamber 104. The air flow between the gas inlet 122 and the gas outlet 124 may be controlled to remove thermal energy from the vessel chamber 104, thereby preventing the temperature of the vessel chamber 104 from exceeding the maximum operating temperature. Other examples of features that are configured to prevent the temperature in the pressure vessel 102 from exceeding the maximum operating temperature includes a heat exchanger (e.g., heat sink) configured to remove thermal energy from the vessel chamber 104, a material disposed in the vessel chamber exhibiting a phase change at a temperature below the maximum operating temperature, or any other suitable feature. It is noted that, due to the elevated temperature of the pressure vessel 102, the vessel walls 110 and the lid 112 may be formed from insulating materials to prevent burning an individual who contacts the pressure vessel 102. For example the vessel walls 110 may include a material with a relatively low thermal conductivity.

The vessel chamber 104 may exhibit a volume of about 0.05 m³ or greater, about 0.1 m³ or greater, about 0.2 m³ or greater, about 0.3 m³ or greater, about 0.4 m³ or greater, about 0.5 m³ or greater, about 0.6 m³ or greater, about 0.8 m³ or greater, about 1 m³ or greater, about 1.25 m³ or greater, about 1.5 m³ or greater, or in ranges of about 0.05 m³ to about 0.2 m³, about 0.1 m³ to about 0.3 m³, about 0.2 m³ to about 0.4 m³, about 0.3 m³ to about 0.5 m³, about 0.4 m³ to about 0.6 m³, about 0.5 m³ to about 0.8 m³, about 0.6 m³ to about 1 m³, about 0.8 m³ to about 1.25 m³, or about 1 m³ to about 1.5 m³. The volume of the vessel chamber 104 is selected to be larger than the volume of the furnace 106, thereby allowing the furnace 106 to be disposed in the vessel chamber 104. In an example, the volume of the vessel chamber 104 is selected to be significantly larger (e.g., larger by about 25% or more, about 50% or more, about 75% or more, or about 100% or more) than the volume of the furnace 106. The significantly larger volume of the vessel chamber 104 relative to the furnace 106 facilitates disposing additional components in the vessel chamber 104, such as a sample dispenser, one or more sensors, etc.

The furnace 106 exhibits a size and shape that is sufficient to fit within the furnace chamber 116. The furnace 106 is configured to controllably increase a temperature thereof. The furnace 106 includes one or more furnace walls 114. The furnace walls 114 define the furnace chamber 116. The furnace chamber 116 is configured to receive a sample and to have the sample autoignite therein. The furnace walls 114 also define an opening (not labelled, covered by the door 118). The opening allows the furnace chamber 116 to be easily accessible. For example, the opening allows the sample to be provided into the furnace chamber 116, allows the furnace chamber 116 to be cleaned (e.g., combusted samples removed therefrom), and allows the furnace 106 to be repaired. The furnace 106 includes a door 118 that is configured to completely cover the opening and be secured to the furnace walls 114. The door 118 may be secured to the furnace walls 114 using any suitable method, such as with clamps, bolts, or hinges.

During use, the furnace 106 may be heated to a temperature that is at least about 50° C. or greater, about 100° C. or greater, about 150° C. or greater, about 200° C. or greater, about 250° C. or greater, about 300° C. or greater, about 400° C. or greater, about 450° C. or greater, about 500° C. or greater, about 550° C. or greater, about 600° C. or greater, about 750° C. or greater, or in ranges of about 50° C. to about 150° C., about 100° C. to about 200° C., about 150° C. to about 250° C., about 200° C. to about 300° C., about 250° C. to about 350° C., about 300° C. to about 400° C., about 350° C. to about 450° C., about 400° C. to about 500° C., about 450° C. to about 550° C., or about 500° C. to about 750° C. The temperature that the furnace 106 is heated to during use may be selected based on a number of factors. In an example, the temperature to which the furnace 106 is heated is selected to be greater than the expected autoignition temperature of the sample. In an example, the temperature to which the furnace 106 is heated is selected to maintain the vessel chamber 104 below the maximum operating temperature. Maintaining the vessel chamber 104 below the maximum operating temperature depends on the thermal conductivity of the furnace walls 114 and the door 118, the size of the sample inlet 120, the amount of air flowing between the gas inlet 122 and the gas outlet 124, the amount of thermal energy lost through the vessel walls 110 and the lid 112, etc. Generally, it has been found that most furnaces may be heated to about 530° C. without causing the temperature of the vessel chamber 104 to exceed the operating temperatures thereof if air is flowing from the gas inlet 122 to the gas outlet 124.

The furnace walls 114 and the door 118 may be formed from any thermally insulating materials that may withstand the temperatures of the furnace 106. In an example, the furnace walls 114 and the door 118 may be formed from a thermally-insulating high-temperature ceramic, steel panels sandwiching a thermally insulating high temperature material, steel panels defining a vacuum chamber, or any other suitable material.

The furnace 106 includes a heater 126 configured to heat the furnace chamber 116. The heater 126 may be disposed in the furnace chamber 116 or otherwise in thermal communication with the furnace chamber 116. The heater 126 may include any suitable device configured to heat the furnace chamber 116. In an example, the heater 126 is a resistive heater, a burner, a heat exchanger configured to transfer thermal energy from a heated fluid to the furnace chamber 116, or any other suitable heater. In an example, the heater 126 may include a fan configured to heat the furnace chamber 116 via convention and to more uniformly heat the furnace chamber 116.

The heater 126 may be positioned to prevent the sample from coming in direct contact with the heater 126 or a flame extending from the heater 126. In an example, the heater 126 is offset laterally from the sample inlet 120 such that any sample disposed through the sample inlet 120 is unlikely to contact the heater 126. In an example, the furnace 106 may include a flask or other container disposed in the furnace chamber 116 that is spaced from the heater 126. The flask or other container is attached to or otherwise positioned to receive any sample disposed through the sample inlet 120. Thus, the flask or other container receives the sample and prevents the sample from contacting the heater 126. In an example, the furnace 106 includes at least one wall that separates the heater 126 from the portions of the furnace chamber 116 that receives the sample. The wall may include perforations and/or thermally conductive material such that the thermal energy from the heater 126 reaches the rest of the furnace chamber 116.

As previously discussed, the furnace 106 defines a sample inlet 120. The sample inlet 120 equalizes the pressure between the vessel chamber 104 and the furnace chamber 116. In other words, the sample inlet 120 allows the furnace chamber 116 to exhibit a pressure of about 101 kPa when the vessel chamber 104 exhibits a pressure of about 101 kPa. The sample inlet 120 also allows a sample to be disposed (e.g., dropped) into the furnace 106. Disposing the sample in the furnace 106 may be a requirement of certain autoignition standards, such as ASTM E659. The surfaces 127 of the furnace 106 that defines the sample inlet 120 may be tapered such that the sample inlet 120 exhibits a funnel-like shape. The funnel-like shape of the sample inlet 120 allows the top of the sample inlet 120 (e.g., the portion of the sample inlet 120 adjacent to the vessel chamber 104) to be large thereby preventing or at least inhibiting the sample from missing the sample inlet 120. The funnel-like shape of the sample inlet 120 also allows the bottom of the sample inlet 120 (e.g., a portion of the sample inlet 120 spaced from the vessel chamber 104, such as a portion of the sample inlet 120 adjacent to the furnace chamber 116) to be small thereby minimizing thermal energy flowing from the furnace chamber 116 to the vessel chamber 104 via the sample inlet 120.

In an embodiment, the furnace 106 may include a temperature controller 128. The temperature controller 128 is configured to control the temperature of the furnace 106. For example, the temperature controller 128 may be communicably coupled to the heater 126 thereby allowing the temperature controller 128 to control the amount of thermal energy released by the heater 126. In an example, when the heater 126 is a resistive heater, the temperature controller 128 is electrically connected to the heater 126 and configured to control at least one of the electrical voltage, current, or power that is provided to the heater 126. In an example, when the heater 126 is a burner, the temperature controller 128 is in fluid communication with the heater 126 such that the temperature controller 128 may control the amount of fuel (e.g., natural gas) that is provided to the heater 126. In an example, when the heater 126 is a heat exchanger, the temperature controller 128 may heat a fluid and be in fluid communication with the heater 126 such that the temperature controller 128 may provide the heated fluid to the heater 126.

In an embodiment, the temperature controller 128 is configured to be manually controlled. In such an embodiment, the temperature controller 128 includes one or more actuators (e.g., knobs) that may be manipulated by an individual. The temperature controller 128 controls the temperature of the furnace 106 responsive to manipulation of the actuator. For example, manipulation of the actuator may cause the temperature controller 128 to increase or decrease at least one of the electrical voltage, the electrical current, the electrical power, the quantity of fuel, or the quantity or temperature of heated fluid that is provided from the temperature controller 128 to the heater 126. In an embodiment, the temperature controller 128 is an electrical circuit that includes at least one processor and at least one memory storage device containing operating instructions. In such an embodiment, the temperature controller 128 may control the amount of thermal energy outputted from the heater 126 responsive to receive the temperature of the furnace chamber 116 from a temperature sensor 130 or responsive to instructions from a controller 132. The instructions stored on the memory storage device may include the rate at which the temperature of the furnace chamber 116 is to be increased, the maximum temperature that the furnace 106 may reach, etc.

In an embodiment, the vessel walls 110 and/or the lid 112 may include at least one vessel transparent section 134 configured to allow an individual to view the vessel chamber 104 during autoignition experiments. The vessel transparent section 134 may include glass, a transparent acrylic panel, or any other suitable material. In an example, the furnace 106 (e.g., the furnace walls 114 and/or the door 118) may include at least one furnace transparent section 134. The transparent sections 134, 136 may be positioned adjacent to each other such that the individual may be able to view the furnace chamber 116 through the transparent sections 134, 136. Allowing the individual to view of the furnace chamber 116 allows the individual to directly view combustion of the sample. In an example, the vessel transparent section 134 may be positioned such that the sample inlet 120 may be easily visible (e.g., the vessel transparent section 134 is positioned above the sample inlet 120). In such an example, the vessel transparent section 134 may allow the individual to indirectly view combustion of the sample. For instance, combustion of the sample may result in a flame leaving the sample inlet 120 or a light being emitted from the sample inlet 120, either of which the individual may be able to view using the vessel transparent section 134. In an embodiment, the pressure vessel 102 does not include a vessel transparent section 134, such as when ignition of the sample may be detected using a camera or using a temperature sensor 130 (e.g., the temperature sensor 130 may detect a spike in the temperature caused by the combustion of the sample).

As previously discussed, the pressure vessel 102 defines a gas inlet 122. The gas inlet 122 may be a hole formed in at least one of the vessel walls 110 (as shown) or in the lid 112. The gas inlet 122 is configured to be in fluid communication with (e.g., connected to) the gas source system 108. For example, the gas inlet 122 may be configured to be directly connected to the gas source system 108 or may be indirectly connected to the gas source system 108 via one or more conduits 138. The gas inlet 122 may be configured to be connected to the gas source system 108 using any suitable technique, such as via a threaded connection, a barbed hose connection, an interference fit, or an adhesive.

The gas source system 108 includes a gas source 140 configured to supply at least one gas (e.g., atmospheric gas) to the vessel chamber 104. The gas source 140 is in fluid communication with the vessel chamber 104 via the gas inlet 122. For example, the gas source 140 may be directly connected to the gas inlet 122 or, more preferably, indirectly connected to the gas inlet 122 via one or more conduits 138 and one or more optional devices (e.g., the air regulator 142, the valve 144, etc.). In an embodiment, the gas source 140 is a compressor or pump that is configured to supply atmospheric air to the vessel chamber 104. In an embodiment, the gas source 140 is a tank of compressed atmospheric air. It is noted that, in some embodiments, it is preferably for the gas source 140 to be a tank of compressed atmospheric air since the atmospheric air from the tank is less likely to include contaminants that may affect the autoignition experiment than the atmospheric air provided by the compressor or pump. For example, the atmospheric air provided by the compressor or pump may include airborne contaminants from a lab or area where the compressor or pump is located. The atmospheric air provided by the compressor or pump may also include oil.

In an embodiment, the gas source system 108 may include one or more air regulators 142 positioned downstream from the gas source 140. The air regulators 142 may be directly connected to the gas source 140 or may be indirectly connected to the gas source 140 using one or more conduits 138 (as shown). The air regulators 142 are configured to control the pressure of the gas provided from the gas source 140 to the vessel chamber 104. For example, the air regulators 142 may control the pressure of the gas such that the pressure of the gas provided to the vessel chamber 104 is about 101 kPa (e.g., to maintain the vessel chamber 104 at about 101 kPa) or is greater than 101 kPa (e.g., about 110 kPa to about 150 kPa, about 125 kPa to about 175 kPa, about 150 kPa to about 200 kPa, or greater than about 200 kPa) to quickly increase the pressure of the vessel chamber 104 to about 101 kPa. The air regulators 142 may include a pressure reducing regulator or a back-pressure regulator.

In an embodiment, the gas source system 108 may include one or more valves 144 that are distinct from the air regulators 142. The valves 144 are configured to permit, restrict, or limit the quantity of gas that is provided to the vessel chamber 104 by the gas source system 108. As such, the valves 144 are located downstream from the gas source 140. The valves 144 may also be located downstream from the air regulators 142 such that the valves 144 are not exposed to high pressure gas which may damage or otherwise adversely affect the efficacy of the valves 144. The valves 144 may include any type of valve. For example, the valves 144 may include a ball valve, a butterfly valve, a choke valve, gate valve, globe valve, knife valve, needle valve, or any other suitable type of valve.

As previously discussed, the pressure vessel 102 defines a gas outlet 124. The gas outlet 124 may be a hole formed in at least one of the vessel walls 110 or in the lid 112 (as shown). The gas outlet 124 is configured to allow the gas in the vessel chamber 104 to controllably escape the vessel chamber 104. Generally, the gas outlet 124 is spaced from the gas outlet 124 (e.g., formed in a different wall of the pressure vessel 102 or on an opposing portion of the pressure vessel 102) such that air flow from the gas inlet 122 to the gas outlet 124 is likely to cause the gas to flow through substantially all of the vessel chamber thereby cooling substantially all of the vessel chamber 104. The gas inlet 122 may include one or more conduits 145 extending therefrom. The conduits 145 may allow fumes from the vessel chamber 104 to be removed a distance from the pressure vessel 102 since such fumes (e.g., fumes from the combustion of the sample) may be unsafe to inhale. For example, the conduits 145 may be disposed in or otherwise in fluid communication with a fume hood.

In an embodiment, the system 100 includes a flow controller 146 configured to control flow of the gas out of the gas outlet 124. The flow controller 146 may include at least one of an air regulator, a valve, or any other device that may permit, prevent, or limit the flow of gas out of the gas outlet 124. In an embodiment, the flow controller 146 is configured to be manually controlled. In such an embodiment, the flow controller 146 includes one or more actuators (e.g., knobs) that may be manipulated by an individual. The flow controller 146 controls the flow of gas out of the gas outlet 124 responsive to manipulation of the actuator. In an embodiment, the flow controller 146 includes an electrical circuit that includes at least one processor and at least one memory storage device containing operating instructions. In such an embodiment, the flow controller 146 may control the amount of gas flowing out of the gas outlet 124 responsive to receive the temperature of the vessel chamber 104 or responsive to instructions from a controller 132.

The system 100 may include one or more pressure sensors that are configured to determine the pressure in the vessel chamber 104 thereby allowing the vessel chamber 104 to exhibit a pressure of about 101 kPa. In an embodiment, not shown, the pressure sensor includes an absolute pressure sensor (e.g. barometer) that is configured to detect the absolute pressure within the vessel chamber 104. In an embodiment, the pressure sensor includes a gauge pressure sensor 148 and an absolute pressure sensor 150. The gauge pressure sensor 148 is configured to detect the pressure differential between the pressure in the vessel chamber 104 and the pressure outside of the pressure vessel 102. As such, the gauge pressure sensor 148 may be disposed in any location where the gauge pressure sensor 148 can detect both the pressure inside and outside the pressure vessel 102. In an example, the gauge pressure sensor 148 is disposed in the vessel walls 110 or the lid 112. In an example, the gauge pressure sensor 148 is disposed in the gas source system 108. In such an example, the gauge pressure sensor 148 may be located downstream the air regulator 142 and the valve 144. The absolute pressure sensor 150 may be located outside of the pressure vessel 102. The gauge pressure sensor 148 and the absolute pressure sensor 150 may be collectively used to determine the absolute pressure within the vessel chamber 104. For example, the absolute pressure in the vessel chamber 104 may be detected by adding the pressure differential detected by the gauge pressure sensor 148 (i.e., the pressure differential is the pressure of the vessel chamber 104 minus the pressure outside the pressure vessel 102) to the absolute pressure detected by the absolute pressure sensor 150.

In some embodiments, it is beneficial to include both the gauge pressure sensor 148 and the absolute pressure sensor 150 rather than using an absolute pressure sensor in the pressure vessel 102 although using both the gauge pressure sensor 148 and the absolute pressure sensor 150 involves more components thereby increasing the complexity of the system 100. In an example, generally, absolute pressure sensors are more voluminous than gauge pressure sensors which makes disposing the absolute pressure sensors in the vessel chamber 104 of the gas supply system 108 difficult. In an example, the pressure within the vessel chamber 104 is likely to change significantly more quickly and often than the pressure outside of the vessel chamber 104. To ensure that the pressure within the vessel chamber 104 is accurate and maintained at 101 kPa, the pressure sensor that detects the pressure within the vessel chamber 104 needs to be able to quickly detect changes in pressure. Generally, gauge pressure sensors are quicker to detect changes in pressure than absolute pressure sensors. Thus, disposing the gauge pressure sensor 148 to detect the pressure in the vessel chamber 104 allows for more accurate measurement of the pressure within the vessel chamber 104 than if the absolute pressure sensor 150 was used to detect the pressure within the vessel chamber 104. In an example, the pressure sensor that detects the pressure in the vessel chamber 104 is more likely to break or need replacement than a pressure sensor that is outside of the pressure vessel 102 due to combustion of the sample and the elevated temperatures of the vessel chamber 104. As such, the gauge pressure sensor 148 is a better sensor to measure the pressure in the vessel chamber 104 because absolute pressure sensors are more expensive and harder to repair than gauge pressure sensors.

As previously discussed, the system 100 includes a temperature sensor 130. The temperature sensor 130 is disposed in the furnace chamber 116, thereby allowing the temperature sensor 130 to detect the temperature within one or more locations of the furnace chamber 116. The temperature sensor 130 may be used to verify that the furnace chamber 116 is being heated as expected and in a controlled manner. The temperature sensor 130 may also be used to determine the temperature at which the sample combusted. For example, the temperature sensor 130 may indicate the temperature of the furnace chamber 116 when combustion of the sample was visually or otherwise detected and/or may detect a sudden increase in the temperature of the furnace chamber 116 caused by the combustion of the sample. The temperature sensor 130 may include any suitable temperature sensor, such as a resistance thermometer, temperature gauge, thermistor, thermocouple, thermometer, or flame detector.

In an embodiment, not shown, the system 100 may include an additional temperature sensor disposed in and configured to detect the temperature of the vessel chamber 104. Such a temperature sensor may be used to ensure that the temperature of the vessel chamber 104 is below the maximum operating temperature thereof. The flow of air from the gas inlet 122 to the gas outlet 124 may be increased if the temperature in the vessel chamber 104 nears the maximum operating temperature thereof.

The system 100 may include one or more additional sensors. For example, the system 100 may include a microphone configured to detect sound generated by the ignition of the sample, an air flow meter configured to detect the amount/flow of gas into and/or out of the vessel chamber 104, a chemical sensor configured to detect the composition (e.g., the presence of impurities) in the gas, a light sensor configured to detect the flame caused by ignition of the sample, any other suitable sensor, of combinations thereof.

In an embodiment, the system 100 includes a controller 132. The controller 132 includes electrical circuitry including at least one processor and at least one memory storage medium storing one or more instruction. The controller 132 is communicably connected to one or more components of the system 100 thereby allowing the controller 132 to receive information from and/or at least partially control the operation of the one or more components of the system 100. For example, as illustrated, the controller 132 is communicably coupled to the temperature controller 128, the temperature sensor 130, the gas source 140, the air regulator 142, the valve 144, the flow controller 146, the gauge pressure sensor 148, and the absolute pressure sensor 150.

In an embodiment, the controller 132 is configured to determine the pressure of the vessel chamber 104 such that the vessel chamber 104 exhibits a pressure of about 101 kPa. For example, the controller 132 may receive one or more signals from the pressure sensors that includes the pressures detected thereby. The signals may include, in the illustrated embodiment, the pressure differential between the vessel chamber 104 and a location outside of the pressure vessel 102 as detected by the gauge pressure sensor 148 and the absolute pressure as detected by the absolute pressure sensor 150. The controller 132 may use the pressure detected by the pressure sensors to cause the vessel chamber 104 to exhibit a pressure of about 101 kPa. In an example, if the controller 132 determines that the pressure is too low or decreasing, the controller 132 may direct at least one of the gas source 140 to supply more gas, the air regulators 142 to increase the pressure of the gas provided to the vessel chamber 104, the valve 144 to open more thereby permitting more gas to flow there through, or cause the flow controller 146 to decrease the amount of gas flowing out the gas outlet 124. In an example, if the controller 132 determines that the pressure is too high or increasing, the controller 132 may direct at least one of the gas source 140 to supply less gas, the air regulators 142 to decrease the pressure of the gas provided to the vessel chamber 104, the valve 144 to close more, or cause the flow controller 146 to increase the amount of gas flowing out the gas outlet 124.

In an embodiment, the controller 132 is configured to determine the temperature within the furnace 106. For example, the controller 132 may direct the temperature controller 128 to increase the temperature in the furnace 106 at a certain rate. The controller 132 may use the temperature of furnace chamber 116 as detected by the temperature sensor 130 to verify that the temperature of the furnace 106 is increasing at the desired rate. The controller 132 may also detect combustion of the sample in the furnace chamber 116 responsive to detecting a sudden increase in the temperature of the furnace chamber 116.

In an embodiment, the controller 132 is configured to determine the temperature within the vessel chamber 104 to ensure that the temperature of the vessel chamber 104 remains below the maximum operating temperature thereof. For example, the controller 132 may direct an increase in the amount of gas flow into and out of the vessel chamber 104 via the gas inlet 122 and the gas outlet 124. Also, the controller 132 may direct the furnace 106 to maintain or even decrease a temperature thereof until the increased amount of gas flowing into and out of the vessel chamber 104 is able to decrease the temperature of the vessel chamber 104.

It is noted that at least one of the processes of the controller 132 may be performed by an individual instead of the controller 132. However, the controller 132 is able to better control the pressure within the vessel chamber 104 and the temperature within the furnace 106 than an individual. For example, it has been found that the controller 132 is able to maintain the pressure in the vessel chamber 104 within about 1 kPa of 101 kPa and, more particularly, within 0.65 kPa and, even more particularly, within 0.4 kPa of 101 kPa. An individual is unable to maintain such tight control of the pressure within the vessel chamber 104. Further, an individual controlling the operation of the components of the system 100 makes it more likely that the individual will fail to detect combustion of the sample than if the controller 132 controlled the operation of the components since the individual's attention is diverted towards controlling the components.

FIG. 2A is a cross-sectional schematic of an autoignition system 200, according to an embodiment. Except as otherwise disclosed herein, the autoignition system 200 is the same as or substantially similar to any of the autoignition systems disclosed herein. For example, the autoignition system 200 includes a pressure vessel 202 defining a vessel chamber 204. The autoignition system 200 also includes a furnace 206 disposed in the vessel chamber 204. It is noted that components of the autoignition system 200 that are either optional and/or not discussed are omitted from FIG. 2A.

The autoignition system 200 includes a sample dispenser 252. The sample dispenser 252 is disposed in the vessel chamber 204 and outside of the furnace 206. In an example, the sample dispenser 252 is disposed on an exterior of the furnace 206 adjacent to the sample inlet 220. The sample dispenser 252 is configured to hold a sample and to controllably dispense the sample into the furnace 206. A portion of the sample dispenser 252 may overhang the sample inlet 220 or be otherwise configured to dispose the sample into the sample inlet 220. It is noted that the sample dispenser 252 may be held over the sample inlet 220 because air flow from the gas inlet 222 to the gas outlet 224 prevents the temperature above the sample inlet 220 from being greater than the temperature within the furnace 206. The sample dispenser 252 may be at least partially controlled by the controller 232.

The sample dispenser 252 includes a sample holder that is configured to hold the sample. The sample holder may include a platform (e.g., bowl, plate, etc.) if the sample is a solid, a container (e.g., an open or closed container) if the sample is a liquid, or any other suitable device that is configured to hold the sample. The sample holder also includes a dispenser that is configured to move the sample from the sample holder to the sample inlet 220. The dispenser may include a motor that rotates the platform, a motor that opens a trap door in the platform, a compressor that compresses the container or increases the pressure in the container, or another other suitable device. FIGS. 2B and 2C illustrate the structure of two particular sample dispensers.

The sample dispenser 252 may allow for more accurate autoignition experiments. In an example, the sample dispenser 202 may only dispense the sample into the furnace 206 when the pressure in the pressure vessel 204 exhibits a constant 101 kPa. It is noted that it is impossible for an individual to dispose the sample in the furnace 206 once the vessel chamber 204 exhibits a pressure of 101 kPa when the pressure outside of the pressure vessel 202 is not 101 kPa. Since the ignition of the sample depends in part on the pressure thereabout, waiting to dispose the sample in the furnace 206 until after the vessel chamber 204 exhibits a pressure of about 101 kPa ensures that the pressure has no effect on the autoignition experiments. In an example, the sample dispenser 242 may only dispense the sample into the furnace 206 until after the furnace 206 reaches a certain temperature since some furnaces may have difficulty initially controlling the temperature thereof.

FIG. 2B is an isometric view of a portion of an autoignition system 200b that includes a sample dispenser 252b disposed over a sample inlet 220b, according to an embodiment. Except as otherwise disclosed herein, the sample dispenser 252b may be the same as or substantially similar to any of the sample dispensers disclosed herein. The sample dispenser 252b includes a base 254b, a platform 256b, and an arm 258b. The arm 258b extends between the base 254b and the platform 256b and connects the base 254b to the platform 256b.

The platform 256b is configured to hold the sample. In the illustrated embodiment, the platform 256b exhibits a bowl-like shape that allows the sample to be disposed in the concave portion of the platform 256b. The concave portion of the platform 256b allows the platform 256b to hold a liquid or solid sample. However, as previously discussed, the platform 256b may exhibit other shapes or structures, such as a planar plate-like structure. In an embodiment, the platform 256b may be formed from an insulating material thereby partially isolating the sample held thereby from the heat flowing through the sample inlet 220 since the platform 256b may be disposed over the sample inlet 220. For example, the platform 256b may be formed from a material exhibiting a thermal conductivity that is about 30 W/(m*K) or less, about 1 W/(m*K) or less, or about 0.01 W/(m*K).

The base 254b is configured to control the movement of the platform 256b. As such, the base 254b may include one or more motors, pneumatic or hydraulic actuators, or other devices that are configured to move the platform 256b (e.g., move the arm 258b). The base 254b may be configured to move the platform 256b in one or more direction. For example, as illustrated, the base 254b may be configured to move the platform 256b in four directions, such as the X direction (e.g., closer and further away from the base 254b), the Y direction (e.g., closer and further away from the sample inlet 220), the Z direction (e.g., perpendicular to the X and Y directions), or in the R direction (e.g., rotate the platform 256b about a central axis of the arm 258b).

Allowing the base 254b to move the platforms 256b facilitates operation of the sample dispenser 252b. In an example, the base 254b may be configured to move the platform 256b such that the platform 256b is only disposed above sample inlet 220 when the platform 256b is dispensing the sample thereby isolating the sample from the heat flowing through the sample inlet 220. In an example, the base 254b may be configured to rotate the platform 256b in the R direction which may cause the platform 256b to dispense the sample into the sample inlet 220.

In an embodiment, as shown, the base 254b may include a housing 260b which may at least partially protect some of the components of the base 254b. The housing 260b may include an opening 262b that allows the arm 258b to move relative to the base 254b. In an embodiment, the base 254b does not include the housing 260b.

FIG. 2C is an isometric view of a portion of an autoignition system 200c that includes a sample dispenser 252c disposed over a sample inlet 220, according to an embodiment. Except as otherwise disclosed herein, the sample dispenser 252c may be the same as or substantially similar to any of the sample dispensers disclosed herein. The sample dispenser 252c includes a base 254c and an arm 258c extending between the base 254b. The base 254c may be configured to move the arm 258c.

The sample dispenser 252c is configured to dispense a liquid. For example, the sample dispenser 252c includes a sample container 264c that is configured to hold the sample. The sample container 264c may be positioned on the housing 260c (as shown), within the housing 260c, on the arm 258c, otherwise positioned on the sample dispenser 252c, or spaced from and in fluid communication with the rest of the sample dispenser 252c. The sample container 264c defines an outlet 266c. In an embodiment, the sample dispenser 252c includes at least one conduit 268c extending from the outlet 266c to the arm 258c. The conduit 268c may be attached to the arm 258c. For example, the arm 258c may include an annular structure and the conduit 268c is dispose in and secured (e.g., with an adhesive or interference fit) to the annular structure. Attaching the conduit 268c to the arm 258c allows at least a portion of the conduit 268c to move with the arm 258c. As such, the arm 258c may move the conduit 268c such that an outlet 270c of the conduit 268c may be positioned over sample inlet 220. In an embodiment, the conduit 168c is omitted from the sample dispenser 252c, such as when the sample container 264c is disposed on the arm 258c.

The sample dispenser 252c may include a dispenser (not shown) attached to or other in fluid communication with the sample container 264c. The dispenser is configured to cause the sample container 264c to dispense the liquid, for example, responsive to direction from the controller 232 (shown in FIG. 2A). In an embodiment, the sample container 264c exhibits a syringe-like structure including a barrel and a plunger. In such an embodiment, the dispenser is configured to move the plunger relative to the barrel to force at least some of the sample disposed in the barrel to exit the sample dispenser. In an embodiment, the dispenser is a pump or other device configured to add air into the sample container 264c. The air added to the sample container 264c may create a pressure within the sample container 264c that forces also of the sample to exit the sample container 264c. In an embodiment, the sample container 264c is compressible and the dispenser is configured to compress the sample container 264c.

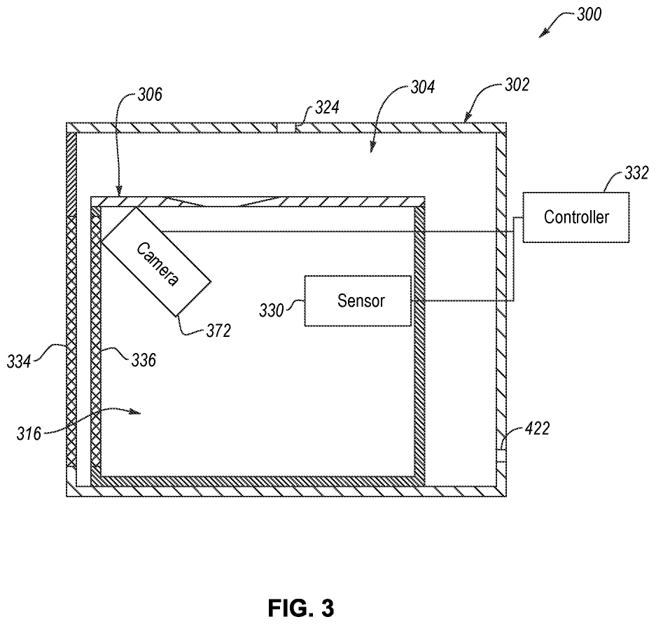

FIG. 3 is a cross-sectional schematic of an autoignition system 300 including a camera 372, according to an embodiment. Except as otherwise disclosed herein, the autoignition system 300 is the same as or substantially similar to any of the autoignition systems disclosed herein. For example, the autoignition system 300 includes a pressure vessel 302 defining a vessel chamber 304, a gas inlet 322, and a gas outlet 324. The autoignition system 300 also includes a furnace 306 disposed in the vessel chamber 304. The furnace 306 defines a furnace chamber 316. The autoignition system 300 may also include other components, such as a controller 332. It is noted that components of the autoignition system 300 that are either optional and/or not discussed are omitted from FIG. 3.

The autoignition system 300 may be configured to detect combustion of a sample within the furnace chamber 316. For example, as previously discussed, the autoignition system 300 may include a temperature sensor 330 disposed in the furnace chamber 316. The temperature sensor 330 may detect a sudden increase in the temperature of the furnace chamber 316. The autoignition system 300 may use the detected increase in temperature of the furnace chamber 316 to detect combustion of the sample. The autoignition system 300 may also visually detect combustion of the sample using at least one camera 372 (e.g., any light sensor). In an example, the camera 372 is disposed in the furnace chamber 316. The camera 372 may be oriented in the furnace chamber 316 such that the expected location of combustion of the sample is within the field of view of the camera 372. As such, the camera 372 may directly visually detect combustion of the sample. In an example, the camera 372 is disposed in the vessel chamber 304 and is oriented towards the sample inlet 320. In such an example, the camera 372 may detect a flame extending out of the sample inlet 320 or a light caused by combustion of the sample. As such, the camera 372 may indirectly visually detect combustion of the sample. In an example, the camera 372 is oriented towards the transparent section 336 of the furnace 306 such that camera 372 can visually detect combustion of the sample through the furnace transparent section 336.

The camera 372 may include any suitable light detecting device. In an example, the camera 372 may be a rugged camera (e.g., a GoPro™ camera) that is configured to operate in adverse environments thereby allowing the camera 372 to operate within the elevated temperatures of the vessel chamber 304 and/or the furnace chamber 316. In an example, the camera 372 may be configured to detect visible light thereby allowing the camera 372 to detect the flame. In an example, the camera 372 is an infrared camera configured to detect the increase temperature of the flame. In an example, the camera 372 may be configured to detect images at a frame rate of about 25 frames per second or greater, about 50 frames per second or greater, about 75 frames per second or greater, or about 100 frames per second or greater. It is noted that the frame rate of the camera 372 indicates how accurately the camera 372 detects the fame. For instance, the camera 372 may detect the flame within about 0.04 seconds of combustion of the sample when the frame rate is about 25 frames per second and detect the flame within about 0.01 seconds of combustion of the sample when the frame rate is about 100 frames per second. It is noted that the human eye is unable to detect a flame more accurately when the camera 372 detects images at a frame rate of about 75 frames per second or greater.

In an embodiment, the camera 372 is communicably coupled with the controller 332. For example, the controller 332 may receive the images detected by the camera 372. The controller 332 may detect combustion of the sample using the images. The controller 332 may use the detected flame to indicate which temperature the sample combusted. In an embodiment, the camera 372 is time synced with at least one of the controller 332, the temperature controller (e.g., temperature controller 128 of FIG. 1), or another device that is tracking the temperature of the furnace 306. The camera 372 may be time synced by being communicably coupled to such devices or by time syncing the camera 372 to such devices prior to the autoignition experiment. Time syncing the camera 372 allows an individual to watch the captured images after the autoignition experiment and determine the time the flame was detected by the camera 372.

Using the camera 372 to visually detect ignition of the sample provides several benefits. In an example, the temperature sensor 330 may be unable to detect the temperature increase caused by combustion of the sample, for instance, due to noise or because the sample is too small to cause a detectable increase in the temperature. The camera 372 may also be able to detect certain properties of the flame (e.g., size and color of the flame) that the temperature sensor 330 is unable to detect. In an example, as previously discussed, at least the pressure vessel 302 includes a transparent section 334 which allows combustion of the sample to be visually detected by an individual outside of the pressure vessel 302. However, it has been found that the individual may miss the combustion of the sample due to the individual being distracted, the transparent section 334 being dirty, or for some other reason. The camera 372 is a fail-safe that allows the combustion of the sample to be detected even if the individual is unable to detect the combustion. In an example, the camera 372 may be able to more accurately detect the time at which the sample combusts than either of detecting the flame with the temperature sensor 330 or visually by an individual. For instance, it may take a moment for the thermal energy released by the combustion of the sample to reach the temperature sensor 330 and an individual visually detecting the combustion may be delayed in documenting the combustion. However, the camera 372 may be able to instantaneously detect the combustion of the sample.

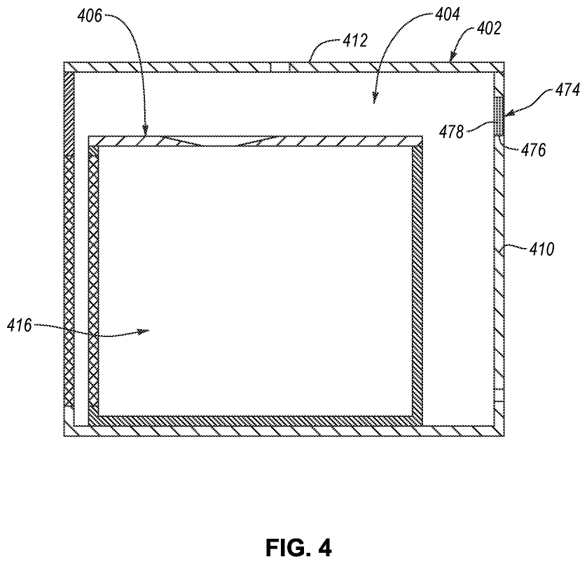

The autoignition systems disclosed herein may include one or more safety features configured to detect or prevent over-pressurization of the pressure vessel 402. For example, FIG. 4 is a cross-sectional schematic of an autoignition system 400 including a safety outlet 474, according to an embodiment. Except as otherwise disclosed herein, the autoignition system 400 is the same as or substantially similar to any of the autoignition systems disclosed herein. For example, the autoignition system 400 includes a pressure vessel 402 defining a vessel chamber 404. The autoignition system 400 also includes a furnace 406 disposed in the vessel chamber 404 defining a furnace chamber 416. The autoignition system 400 may also include other components. It is noted that components of the autoignition system 400 that are either optional and/or not discussed are omitted from FIG. 4.

The pressure vessel 402 may be configured to withstand a pressure differential (i.e., gauge pressure) between the vessel chamber 404 and an exterior of the pressure vessel 402 that is below a threshold value. The threshold value may be about 25 kPa or greater, about 50 kPa or greater, about 75 kPa or greater, about 100 kPa or greater, about 150 kPa or greater, about 200 kPa or greater, about 300 kPa or greater, about 400 kPa or greater, or about 500 kPa or greater. These threshold values allows the pressure in the vessel chamber 404 to exhibit a pressure of about 101 kPa without the pressure vessel 402 failing (e.g., exploding). It is noted that the likelihood of the pressure vessel 402 fails when the pressure differential is below the threshold value is essentially 0% while the likelihood of the pressure vessel 402 fails when the pressure differential is above the threshold value may be greater than 0%. Malfunctions of the autoignition system 400 may cause the pressure differential between the vessel chamber 404 and an exterior of the pressure vessel 402 to exceed the threshold value. The autoignition system 400 may include the safety valve 474. The safety valve 474 is configured to allow gas to exit the vessel chamber 404 when the pressure differential is at, near, or, above the threshold value thereby preventing the pressure vessel 402 from failing. For example, the safety valve 474 may allow the gas to exit the vessel chamber 404 if the pressure differential exceeds about 50 kPa, about 100 kPa, about 150 kPa, about 200, about 300 kPa, about 400 kPa, or about 500 kPa.

The safety valve 474 includes passageway 476 defined by the pressure vessel 402. For example, the passageway 476 may be formed in the vessel walls 410 (as shown) or the lid 412. The safety valve 474 includes a barrier 478 disposed in or over the passageway 476. Generally, the barrier 478 of the safety valve 474 closes (e.g., obstructs) the passageway 476 such that gas cannot flow through the passageway 476. However, the barrier 478 of the safety valve 474 is configured to opening the passageway 476 when the pressure differential is at, near, or above the threshold value. Opening the passageway 476 allows gas to exit the vessel chamber 404. In a particular example, the barrier 478 of the safety valve 474 includes a film (e.g., aluminum foil) covering or disposed in the passageway 476. The film is configured to fail (e.g., rupture or become at least partially detached from the pressure vessel 402) when the pressure differential between the vessel chamber 404 and an exterior of the pressure vessel 402 is near, at, or above the threshold value. For example, the film may be configured to fail when the pressure differential between the vessel chamber 404 and an exterior of the pressure vessel 402 is about 50 kPa to about 100 kPa, about 75 kPa to about 125 kPa, about 100 kPa to about 150 kPa, about 125 kPa to about 200 kPa, about 150 kPa to about 250 kPa, about 200 kPa to about 300 kPa, about 250 kPa to about 350 kPa, about 300 kPa to about 400 kPa, about 350 kPa to about 450 kPa, or about 400 kPa to about 500 kPa. The pressure differential that causes the film to fail may be controlled by modifying the thickness of the film (e.g., decreasing the thickness of the film decreases the pressure differential that causes the film to fail) or varying the adhesive strength of the adhesive that attached the film to the pressure vessel 402.

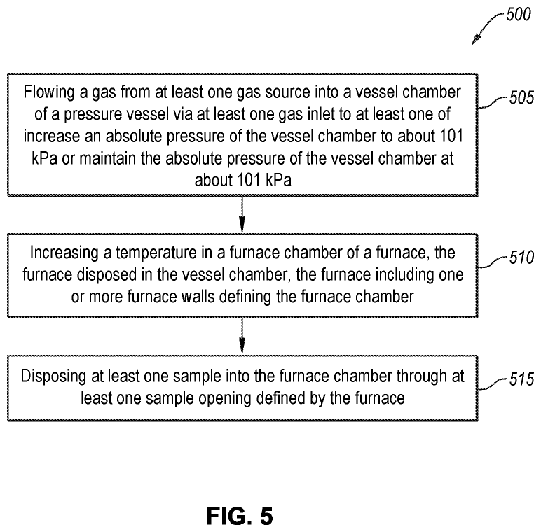

FIG. 5 is a flow chart of an example method 500 of using any of the autoignition systems disclosed herein, according to an embodiment. The example method 500 includes one or more operations, functions, or actions illustrated by one or more of blocks 505, 510, or 515. The operations, functions, or actions of the example method 500 may be performed, for example, by the controller.

The example method 500 may include block 505, which includes “flowing a gas from at least one gas source into a vessel chamber of a pressure vessel via at least one gas inlet to at least one of increase an absolute pressure of the vessel chamber to about 101 kPa or maintain the absolute pressure of the vessel chamber at about 101 kPa.” The example method 500 may include block 510, which includes “increasing a temperature in a furnace chamber of a furnace, the furnace disposed in the vessel chamber, the furnace including one or more furnace walls defining the furnace chamber.” The method 500 may include block 515, which includes “disposing at least one sample into the furnace chamber through at least one sample opening defined by the furnace.”

The blocks of the method 500 are provided for illustrative purposes only. In some examples, the blocks of the method 500 may be performed in an order that is different than what is illustrated in FIG. 5. In an example, one or more of the blocks may be eliminated, divided into two or more blocks, supplemented, or combined. It is noted that additional features of the method 500 are disclosed above.

Block 505 includes “flowing a gas from at least one gas source into a vessel chamber of a pressure vessel via at least one gas inlet to at least one of increase an absolute pressure of the vessel chamber to about 101 kPa or maintain the absolute pressure of the vessel chamber at about 101 kPa.” As previously discussed, the gas source may include a compressor, pump, or tank of air. The gas source is configured to provide atmospheric gas to the vessel chamber. Block 505 may include flowing the atmospheric air from the gas source into the vessel chamber via the gas inlet. In some embodiment, flowing the atmospheric air from the gas source into the vessel chamber includes flowing the atmospheric air through one or more air regulators or one or more valves that are positioned downstream from the gas source.

Block 510 includes “increasing a temperature in a furnace chamber of a furnace, the furnace disposed in the vessel chamber, the furnace including one or more furnace walls defining the furnace chamber.” At least a portion of block 510 may be performed before, simultaneously with, or after block 505. Block 510 may include slowly increasing the temperature of the furnace chamber until the sample disposed in the furnace chamber combusts. Block 510 may include stopping to heat the furnace chamber after combustion of the sample is detected or may include increasing the temperature of the furnace chamber to ensure that the sample completely combusted.

Block 515 includes “disposing at least one sample into the furnace chamber through at least one sample opening defined by the furnace.” Block 515 may be performed before, during, or after block 505 and before or during block 510. In an embodiment, block 515 may include disposing the sample into the furnace chamber using a sample dispenser. In such an embodiment, block 515 may include rotating a platform holding the sample or dispensing a fluid sample from a sample container.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean±10%, ±5%, or ±2% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

1. An autoignition system to measure autoignition temperatures, the autoignition system comprising:
a pressure vessel including one or more vessel walls defining a vessel chamber and opening, the pressure vessel including a lid configured to cover the opening and be secured to the one or more vessel walls, the pressure vessel defining at least one gas inlet;
a furnace disposed in the vessel chamber, the furnace including one or more furnace walls defining a furnace chamber, the furnace defining at least one sample inlet configured to allow a sample to be disposed in the furnace chamber, the furnace configured to controllably heat the furnace chamber;
at least one gas source in fluid communication with the gas inlet of the pressure vessel; and
at least one pressure sensor configured to detect a pressure within the vessel chamber.

2. The autoignition system of claim 1, wherein the pressure vessel defines at least one gas outlet.

3. The autoignition system of claim 2, further comprising at least one flow controller in fluid communication with the at least one gas outlet, the at least one flow controller configured to control flow of a gas through gas outlet.

4. The autoignition system of claim 1, wherein the one or more vessel walls include at least one vessel transparent section.

5. The autoignition system of claim 4, wherein the furnace walls include at least one furnace transparent section, the vessel transparent section and the furnace transparent section are adjacent to each other.

6. The autoignition system of claim 1, wherein the pressure vessel includes at least one safety outlet, the at least one safety outlet defining a passageway and a film disposed in or covering the passageway, the film configured to fail when a pressure differential between the vessel chamber and an exterior of the pressure vessel is about 100 kPa to about 500 kPa.

7. The autoignition system of claim 1, wherein the at least one gas source includes a tank of atmospheric air.

8. The autoignition system of claim 1, wherein the at least one gas source includes a pump configured to receive atmospheric gas.

9. The autoignition system of claim 1, wherein the at least one pressure sensor includes a gauge pressure sensor configured to detect a gauge pressure between the vessel chamber and an exterior of the pressure vessel and an absolute pressure sensor configured to detect an absolute pressure in the exterior.

10. The autoignition system of claim 1, further comprising a sample dispenser disposed in the vessel chamber and outside of the furnace chamber, the sample dispenser configured to dispense at least one sample into the furnace chamber through the at least one sample inlet.

11. The autoignition system of claim 10, wherein the sample dispenser includes an arm that is configured to move in at least one direction.

12. The autoignition system of claim 11, wherein the arm is configured to move in four directions.

13. The autoignition system of claim 10, wherein the sample dispenser further includes a platform attached to the arm, the platform configured to hold a solid sample.

14. The autoignition system of claim 10, wherein the sample dispenser further includes:
a sample container configured to hold a fluid sample, the sample container defining a sample outlet;
a conduit extending from the sample outlet, the conduit defining a conduit outlet disposable over the at least one sample inlet; and
a dispenser configured to controllably allow the fluid sample to flow out of the sample container, through the conduit, and out the conduit outlet.

15. The autoignition system of claim 1, further comprising a camera disposed in the furnace chamber.

16. The autoignition system of claim 1, further comprising a controller, the controller configured to control at least one of a rate at which a gas is provided from the gas source to the vessel chamber or a temperature in the furnace chamber.

17. The autoignition system of claim 1, further comprising a gas source system, the gas source system include the gas source, at least one of one or more air regulators or one or more valves downstream from the gas source, and one or more conduits that fluidly connect the at least one gas source to the at least one gas inlet.

18. The autoignition system of claim 17, wherein the gas source system includes the at least one pressure sensor downstream from the at least one of the one or more air regulators or the one or more valves.

19. A method to measure autoignition temperatures, the method comprising:
flowing a gas from at least one gas source into a vessel chamber of a pressure vessel via at least one gas inlet to at least one of increase an absolute pressure of the vessel chamber to 101 kPa or maintain the absolute pressure of the vessel chamber at 101 kPa, the pressure vessel including one or more vessel walls defining the vessel chamber and an opening, the pressure vessel including a lid covering the opening and secured to the one or more vessel walls, wherein the absolute pressure of the vessel chamber is detected using at least one pressure sensor;
increasing a temperature in a furnace chamber of a furnace, the furnace disposed in the vessel chamber, the furnace including one or more furnace walls defining the furnace chamber; and
disposing at least one sample into the furnace chamber through at least one sample inlet defined by the furnace.

20. An autoignition system to measure autoignition temperatures, the autoignition system comprising:
a pressure vessel including one or more vessel walls defining a vessel chamber and opening, the pressure vessel including a lid configured to cover the opening and be secured to the one or more vessel walls, the one or more vessel walls including at least one vessel transparent section, the pressure vessel defining at least one gas inlet and at least one gas outlet;
a furnace disposed in the chamber, the furnace including one or more furnace walls defining a furnace chamber, the furnace defining at least one sample inlet configured to allow a sample to be disposed in the furnace chamber, the furnace configured to controllably heat the furnace chamber;
a sample dispenser disposed in the vessel chamber and outside of the furnace chamber, the sample dispenser configured to dispense at least one sample into the furnace chamber through the at least one sample inlet;
at least one gas source in fluid communication with the gas inlet of the pressure vessel;
at least one pressure sensor configured to detect a pressure within the vessel chamber;
a controller configured to control at least one of a rate at which a gas is provided from the gas source to the vessel chamber or a temperature in the furnace chamber; and
at least one safety outlet defining a passageway and a film disposed in or covering the passageway, the film configured to fail when a pressure differential between the vessel chamber and an exterior of the pressure vessel is about 100 kPa to about 500 kPa.
